(19) United States
(12) Patent Application Publication
(10) Pub. No.: US 2026/0030985 A1
(43) Pub. Date: Jan. 29, 2026

(54) CLOUD-BASED COOPERATIVE SPEED ENFORCEMENT SYSTEM AND METHOD

(71) Applicant: Applied Concepts, Inc., Richardson, TX (US)

(72) Inventors: Russell D. Kautz, Lewisville, TX (US); James He, Richardson, TX (US); Danny Joe Beasley, Richardson, TX (US)

(73) Assignee: Applied Concepts, Inc., Richardson, TX (US)

(21) Appl. No.: 19/280,511

(22) Filed: Jul. 25, 2025

Related U.S. Application Data
(60) Provisional application No. 63/675,521, filed on Jul. 25, 2024.
(60) Provisional application No. 63/709,106, filed on Oct. 18, 2024.

(51) Int. Cl. G08G 1/0967; G01S 13/58; G08G 1/052

(52) U.S. Cl. CPC G08G 1/096775; G01S 13/58; G08G 1/052

(57) ABSTRACT

A system for processing law enforcement data, including a speed detection system operating on a processor and configured to generate target vehicle speed information, a spotter system operating on a second processor, the spotter system configured to receive the target vehicle speed information and generating notification data and one or more chase system, each operating on an associated third processor, each chase system configured to receive the notification data and to identify a target vehicle associated with the notification data.

### RELATED APPLICATIONS

The present application claims benefit of and priority to U.S. provisional patent application 63/675,521, filed Jul. 25, 2024, and U.S. provisional patent application 63/709,106, filed Oct. 18, 2024, which is hereby incorporated by reference for all purposes as if set forth herein in its entirety.

### TECHNICAL FIELD

The present disclosure relates generally to speed enforcement, and more specifically to a cloud-based cooperative speed enforcement system that allows a team of law enforcement officers to more effectively enforce traffic speed limits.

### BACKGROUND OF THE INVENTION

Traffic speed control is an essential component of protecting the health and safety of the public. Despite that well-recognized principle, many traffic accidents are caused every year by speeders, some of which are fatal.

### SUMMARY OF THE INVENTION

A system for processing law enforcement data is disclosed. The system includes a speed detection system operating on a processor and configured to generate target vehicle speed information, such as a radar or Lidar speed detection system. A spotter system operating on a second processor that is remote from the first processor, such as a smart telephone, is configured to receive the target vehicle speed information and to generate notification data. One or more chase systems, each operating on an associated third processor such as a smart phone at each chase vehicle, are configured to receive the notification data and to identify a target vehicle associated with the notification data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for a cloud-based cooperative speed enforcement system, in accordance with an example embodiment of the present disclosure;

FIG. 2 is a diagram of an algorithm for a cloud-based cooperative speed enforcement system, in accordance with an example embodiment of the present disclosure; and

FIG. 3 is a diagram of an algorithm for selecting chase vehicles in a cloud-based cooperative speed enforcement system, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. provisional patent application 63/675,521, filed Aug. 6, 2024, which is hereby incorporated by reference for all purposes as if set forth herein in its entirety.

The present disclosure provides systems and methods that use Lidar, radar or other suitable tools to provide speed enforcement officers with an automated system for performing team enforcement of speed limits. The systems and methods can include one or more smartphone applications and associated web services that can interact with Lidar, radar or other suitable tools to automate identification, tracking and citation of drivers of vehicles that are violating traffic safety laws and regulations.

Previously, in a typical chase scenario using a Lidar device, a radar or other suitable tools, a spotter officer would position themselves on a road to log speeds or other unsafe driving conditions of passing vehicles, which typically result from a violation of laws or regulations. When a violating vehicle is detected, the spotter officer would use a radio to contact a chase officer or officers with a verbal description of the target vehicle, but that process is prone to error. The spotter officer would then wait for a chase officer to response, and if more than one responded it would be necessary to try to coordinate actions of the chase officers. Often, the spotter officer and the chase officers would not be in visual range of each other, and it would be necessary for additional communications between the officers that would create delays and result in the target vehicle evading the citation.

Using the systems and methods of the present disclosure, it is possible to avoid losing targets due to confusion from inefficient coordination and communications. The spotter officer uses a spotter system to capture and transmit the speed, image data and additional vehicle description data to a group of chase officers down the road, such as at a staging area or at different locations, who are prepared to pursue the driver of the offending target vehicle. One or more of the chase officers can be assigned to the target vehicle, such as by using maps on chase systems used by each chase officer to determine the closest chase officer who is available to engage the target vehicle. The selected chase officer or officers can receive the image data and additional vehicle description data, without the need for verbal descriptions and the potential for miscommunication. When the chase officer pulls over the offending target vehicle to give them a citation for the associated violation of a relevant moving vehicle law, they can generate image data to confirm the identity of the target vehicle, and the data generated in association with the chase can be stored to a cloud server and used to automatically populate relevant data fields of the citation. The chase officers can then return to the staging area and to wait for the next violation, or can receive violation data at their current location, which can be updated on the maps of the spotter system and chase systems.

In one example embodiment of the present disclosure, the spotter officer measuring the speeds or other violations of passing vehicles can use a spotter system implemented as a smartphone application or as an application on other suitable computing devices, a dedicated system or other suitable systems to connect to a centralized or distributed processing system, such as a system hosted in a cloud server environment. The spotter system can generate a user interface with associated used controls that show the spotter officer's location on a map, locations of chase officers, the target vehicle location, speed and image and other suitable data. The system can be a web service or other suitable computing service that launches a program thread that creates a database instance unique to the chase operation associated with the vehicle. The chase system can be implemented as a second smartphone application or an application on suitable computing devices, a dedicated system or other suitable systems used by chase officers and can generate a user interface with associated used controls that show the chase officer a location on a map of the chaser officers, the spotter officer, the target vehicle and other suitable data. The chase officers assigned to the target vehicle can use one or more controls to confirm the location data and can also generate additional data, such as the road direction they will be working. This data can be logged to the web service or to other suitable database structures that are coordinated to interact with the service.

The spotting officer can “lock in” the violation of the target vehicle using the spotting system, such as a speed violation with Lidar, radar or other suitable tools, or can otherwise document the traffic law or regulation violation, such as with image data or video data. In one example embodiment, a citation can require additional information, such as 1) location data, 2) officer identification data, 3) offending vehicle identification data, 4) weather data, 5) time of day and date data, and other suitable data, and the necessary data can be used to pre-populate a citation data record. The Lidar or radar device can transmit speed data to the spotter system operating on the smartphone application or other devices, such as wirelessly by Bluetooth, Wi-Fi, 5G or other suitable media, by a wireline media or in other suitable configurations. The spotter system can save an image of the target vehicle that has been synchronized with data identifying the infraction, such as the speed data from the Lidar or radar. The image and speed data can be time-stamped and saved by the web service in the cloud computing environment or other suitable database structures that are coordinated to interact with the web service.

One or more chase officers can then receive a notice on the chase system on their smartphone application or other suitable devices when a new violation has been logged into the database. Chase officers can be selected using the spotter system, can be selected as a function of availability, can be selected in response to activation of an “available” control on a chase system operated by the chase officer, or can be selected in other suitable manners. The chase system for each selected chase officer can display an image of the target vehicle associated with the infraction, a description of the infraction (such as the violation speed), relevant data about the driver (such as prior arrests for violent crimes), and the officers can “claim” a vehicle using a control of the chase system and initiate a pursuit. In one example embodiment, one chase officer can “claim” a vehicle, to optimize the use of resources and to avoid duplication of efforts, and the other chase officers can be notified that the vehicle has been claimed. In another example embodiment, a driver with a record of violent crimes or with other prior history that warrants additional caution can cause the spotter system to seek additional officers to assist with the chase. When one of the chase officers has stopped the target vehicle, their chase system can register when the officer's vehicle movement and the target vehicle movement have stopped. As part of the violation processing, the location can be logged with associated data, such as map coordinates and time/date. The chase system of the officer can generate a control that can be used to capture an image of the target vehicle and license tag. All data associated with the violation can be automatically uploaded to the cloud server or other associated database, and a status of “closed” can be assigned to the chase event after the driver of the target vehicle has accepted the citation and left the scene.

At the end of the chase operation, the data generated by the spotter system and the chase systems that were engaged in the chase operation can be stored to a cloud data server with an associated ticket or event tracking number. This data can be used to support ticket generation and a post analysis of the effectivity of the operation.

The present disclosure can be implemented with one or more of the following components:
1) A Lidar, radar or other speed detection tool with one or more of these or other attributes: A) Fully integrated wireless communications such as Bluetooth, Wi-Fi, 5G or other suitable communications allowing it to connect to a smartphone application or other suitable device and to send real time data. B) An integrated magnetometer that can provide the pointing direction of the speed detection tool. C) Suitable interactive menu options as discussed described in further detail herein.
2) A dedicated server or web service with one or more of these or other attributes: A) The ability to set up a uniquely identified database instance by the smartphone application or other suitable device in spotter mode that predetermined data will be logged to. B) The ability to allow one or more other devices, including chase systems, to connect to that database instance when they enter a unique identifier. C) The ability to store and retrieve data and images generated by each spotter system and chase system. D) The ability to generate automated reports containing data on each selected chase event. E) The ability to generate automated reports that summarize the chase activities collectively, as discussed described in further detail herein.
3) A smartphone application or other suitable device that hosts a spotter system and a chase system and provides one or more of these or other capabilities: A) Two or more modes of operation, including spotter mode and chase mode. B) When in spotter mode, the spotter system creates a unique chase instance on the web service or other central service where data will be centralized and stored. C) User-selectable speed threshold controls that are used as a trigger to identify a target vehicle and start a chase. D) A map-based user interface that displays the current location of the spotter system or chase system. The user interface can also separately show the Lidar or radar tool location, the direction of the target, and other data as discussed described in further detail herein where suitable. E) The user-interface of the spotter system can display the location of the waiting chase vehicles. The locations can be uploaded to the web service by the mapping programs of the spotter system, the chase systems, resident mapping functionality of the host devices for the spotter system and chase systems, or other devices of officers associated with the chase vehicles. F) The spotter system and chase systems can include a camera or can use a resident camera of a host device, such as a smartphone camera, and can be activated and set up on a tripod facing the direction of traffic to be tracked. The spotter system and chase systems can be configured to capture a vehicle image having suitable evidentiary attributes (e.g. size, resolution brightness). G) When the Lidar, radar or other device trigger is pulled, speed data and other suitable can be sent in real time to the spotter system, which can record speed, distance, pointing angle or other suitable data from the Lidar, radar or other device, as discussed described in further detail herein. H) When the trigger of the device is released (or some other tracking event occurs), the event data can be sent to the spotter system to trigger a frame grab from the camera and to save the image, such as an image of the car being tracked. I) The user interface of the spotter system and chase systems can be updated with the maximum speed recorded, and an overlay on the map showing the path of the vehicle tracked, such as by using the distance and direction data from the Lidar, radar or other device or in other suitable manners. J) If the speed is above a threshold, the spotter system can send a data message to the Lidar, radar or other device using Bluetooth or other suitable media, and the spotter system can generate a display screen and head's up display (HUD) that a valid infraction has been captured, so the spotting officer does not have to put down the device. K) The Lidar, radar or other device can be configured so one of its buttons becomes a HOT key, that when pressed instructs the spotter system (such as via Bluetooth or other suitable medium) to send the information to the web service or other central server and to start a chase event. L) As an alternative, the user interface of the spotter system can have a soft key on its display to allow a second officer to man the spotter system and make decisions on whether to start a chase. M) A summary screen can be accessed on the spotter system to allow the spotting officer to view a summary of the activity logged to the web service or central server. This data can contain items such as the number of chase reports sent, the number of target vehicles that were successfully completed and ticketed, the number of cars tracked, and other summary data. N) The user interface of the spotter system can create a messaging window with the chase systems, such as to facilitate communications between spotting officer and the chase officers or for other suitable purposes.
4) The chase system can include one or more of the following features, in addition to other noted features: A) Log the position of the chase vehicle before and after the chase. B) Inform the chase officer when data has been stored on the web service or central server to initiate a chase. C) Provide information to the chase office of car image and traffic violation. D) Provide the ability of the chase officer to log the results of the chase along with images.

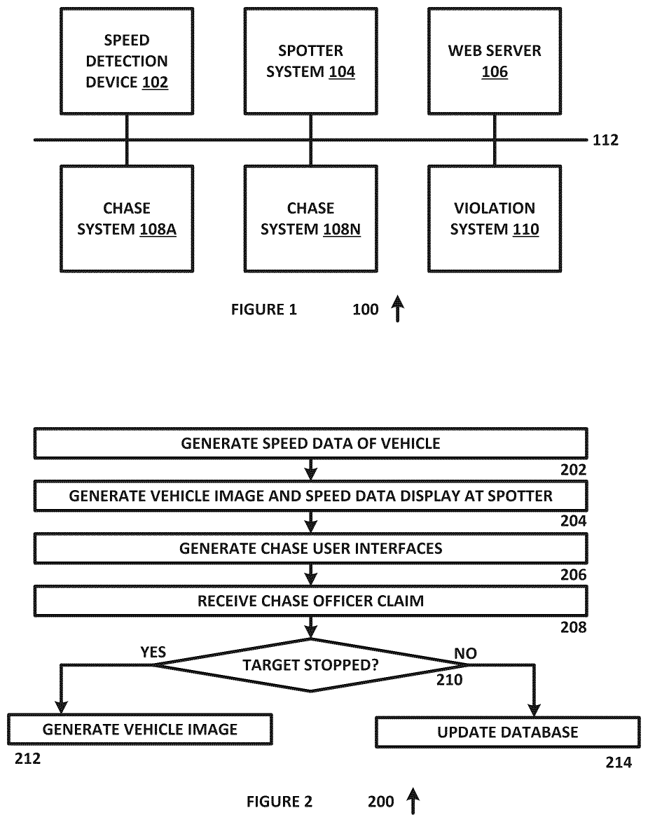

FIG. 1 is a diagram of a system 100 for a cloud-based cooperative speed enforcement system, in accordance with an example embodiment of the present disclosure. System 100 includes speed detection device 102, spotter system 104, web server 106, chase systems 108A through 108N, violation system 110 and communications media 112, each of which can be implemented in hardware or a suitable combination of hardware and software.

Speed detection device 102 can be implemented in hardware or a suitable combination of hardware and software, and can be one or devices that use radar, Lidar or other suitable mechanisms to determine a speed of a target vehicle. In one example embodiment, speed detection device 102 can be one or more of the devices disclosed in U.S. Pat. Nos. 8,125,622, 6,831,593, 7,068,212, 7,038,614 and 5,525, 996, each of which is hereby incorporated by reference for all purposes as if set forth herein in their entireties. Speed detection device 102 can include one or more algorithms stored in a data memory device that can be loaded into a working memory of a processor that can be executed by the processor to cause the processor to interface with spotter system 104, web server 106, chase systems 108A through 108N, violation system 110 and communications media 112, as discussed and disclosed herein, or to perform one or more of the algorithmic processes discussed and disclosed herein.

Spotter system 104 can include one or more algorithms stored in a data memory device that can be loaded into a working memory of a processor that can be executed by the processor to cause the processor to generate a user interface and associated controls for coordinating enforcement action against a vehicular traffic law violator or other suitable persons. In one example embodiment, spotter system 104 can be a smartphone application or other suitable systems that can interface with speed detection device 102, such as to receive data from speed detection device 102, to query speed detection device 102 for data and to perform other suitable functions. Spotter system 104 can generate a user display that shows a vehicle image, a speed, and associated vehicle data such as whether the driver has outstanding arrest warrants or requires special considerations for apprehension. Spotter system 104 can initiate an enforcement data record that is used to track activities associated with a vehicle, where the enforcement data record can be saved to a cloud computing server, can be made available to one or more chase officer devices or for other suitable purposes. In another example embodiment, spotter system 104 can be implemented as a thin client application of a web browser that is controlled by the web server, or other suitable configurations can also or alternatively be used.

Web server 106 can include one or more algorithms stored in a data memory device that can be loaded into a working memory of a processor that can be executed by the processor to cause the processor to interface with speed detection device 102, spotter system 104, chase systems 108A through 108N, violation system 110 and communications media 112 and to send and receive data over communications media 112, as discussed and described herein. Web server 106 can generate a master data record for each vehicular traffic violation event, including but not limited to vehicle image data, vehicle speed data, spotter officer and vehicle identification and location data, speed detection device data such as device identification data and angle data, geographic coordinate data, chase officer identification and location data, vehicle image and location data generated by the chase system, citation data, outstanding warrant data, alcohol or drug impairment test data, arrest record data and other suitable data.

Chase systems 108A through 108N can include one or more algorithms stored in a data memory device that can be loaded into a working memory of a processor that can be executed by the processor to cause the processor to generate a user interface and associated controls for coordinating enforcement action against a vehicular traffic law violator or other suitable persons. In one example embodiment, chase systems 108A through 108N can be smartphone applications or other suitable systems that can interface with spotter system 104, web server 106 or communications media 112, such as to receive data from spotter system 104, to query spotter system 104 for data and to perform other suitable functions. Chase systems 108A through 108N can generate a user display that shows a vehicle image, a speed, and associated vehicle data such as whether the driver has outstanding arrest warrants or requires special considerations for apprehension. Chase systems 108A through 108N can receive and update an enforcement data record that is used to track activities associated with a vehicle, where the enforcement data record can be saved to a cloud computing server, can be made available to one or more chase officer devices or for other suitable purposes. In another example embodiment, chase systems 108A through 108N can be implemented as a thin client application of a web browser that is controlled by the web server, or other suitable configurations can also or alternatively be used.

Violation system 110 can include one or more algorithms stored in a data memory device that can be loaded into a working memory of a processor that can be executed by the processor to cause the processor to generate a vehicular violation citation or to perform other suitable functions. In one example embodiment, violation system 110 can generate a citation that can be provided to the driver of a vehicle, and which contains information that is required by law, such as the identification of the citing officer, the specific details of the traffic violation, contact information and other suitable data. Violation system 110 can receive signature data from an offender to establish that the offender received and understood the citation, video data generated during the interaction of the officer with the offender and other suitable data.

Communications media 112 can be one or more wireless communications media, wireline communications media, a suitable combination of communications media or other suitable systems that facilitate data communications between connected devices. Communications media 112 can include and data security features, such as to prevent unauthorized third parties from accessing data generated by the system components of system 100. The data security features can include session-related security data such as a session identifier that is transmitted to an authorized device to prevent unauthorized persons from accessing chase-related episode data for a target vehicle, where each chase episode include a unique identifier that must be provided from a spotter system 104, web server 106 or chase system 108A-108N, and where the unique identifier is associated with a device identifier of the systems that are authorized to access the data.

In operation, system, 100 can be used to implement the features and functions discussed and disclosed herein to allow vehicle traffic law violators to be identified and ticketed, such as drivers of speeding vehicles, drivers who are under the influence of alcohol or drugs, drivers with outstanding warrants or for other suitable purposes.

FIG. 2 is a diagram of an algorithm 200 for a cloud-based cooperative speed enforcement system, in accordance with an example embodiment of the present disclosure. Algorithm 200 can be used to coordinate vehicle law enforcement activities and can be implemented in hardware or suitable combination of hardware and software.

Algorithm 200 begins at 202, where a speed of a vehicle is generated. In one example embodiment, the speed can be generated using a radar device, a Lidar device, or other suitable devices. The algorithm then proceeds to 204.

At 204, vehicle image data and speed data are generated in a display at a spotter device. In one example embodiment, the spotter device can be implemented as one or more algorithms operating as a smartphone application, or other suitable devices used by a first law enforcement official to identify vehicles that are violating speed laws or other suitable laws. The display can include vehicle image data, the associated speed of the vehicle and other suitable data. The algorithm then proceeds to 206.

At 206, a chase vehicle selection user interface is generated. In one example embodiment, the chase vehicle selection user interface can be generated on the spotter device and can allow the officer operating the spotter device to select one or more chase vehicles to handle tracking and citing the offending vehicle. Likewise, other suitable processes can also be used. The algorithm then proceeds to 208.

At 208, a chase officer claim is received. In one example embodiment, where two or more officers are presented with the opportunity to chase an offending vehicle, the first officer to respond can be assigned the vehicle. Likewise, other suitable processes can also or alternatively be used. The algorithm then proceeds to 210.

At 210, it is determined whether the target vehicle has been stopped. If the target vehicle has not been stopped, the algorithm proceeds to 214 and the database is updated, such as to show that the chase is in progress, to show the target vehicle has been lost, or other suitable data. Otherwise, the algorithm proceeds to 212.

At 212, a vehicle image is generated. In one example embodiment, the vehicle image can be generated by a chase officer who has pulled the vehicle over, such as by using an image data capture device of a smartphone to document that the correct vehicle has been stopped and is associated with the speeding data. Likewise, other suitable data can be entered, generated, or other suitable processes can also or alternatively be used as discussed described in further detail herein.

In operation, algorithm 200 allows coordination of law enforcement activities to be implemented. Although algorithm 200 is shown as a flow chart, a person of ordinary skill in art will recognize that it can also or alternatively be implemented as a ladder diagram, as a state diagram, using object-oriented variables, in other suitable manner or in a combination of suitable manners.

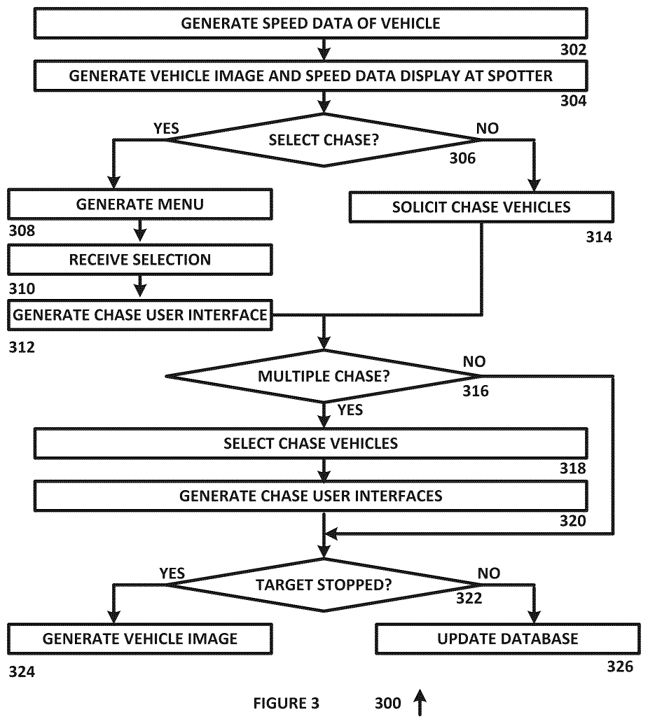

FIG. 3 is a diagram of an algorithm 300 for selecting chase vehicles in a cloud-based cooperative speed enforcement system, in accordance with an example embodiment of the present disclosure. Algorithm 300 can be used to coordinate vehicle law enforcement activities and can be implemented in hardware or suitable combination of hardware and software.

Algorithm 300 begins at 302, where the speed of a vehicle is generated. In one example embodiment, the speed data can be generated using a radar device, a Lidar device or other suitable devices. The algorithm then proceeds to 304.

At 304, vehicle image data, speed data and other suitable data is generated in a display at a spotter device. The data can also be stored to a cloud database for use in generating a citation or for other suitable purposes. The algorithm then proceeds to 306.

At 306, it is determined whether the spotter has selected a chase vehicle. If the spotter has not selected a chase vehicle, the algorithm proceeds to 314, otherwise the algorithm proceeds to 308.

At 308, a menu is generated at the spotter device user interface. In one example embodiment, chase vehicles can register their availability, chase vehicle availability can be automatically determined based on vehicle location and status data, or other suitable processes can also or alternatively be used. The menu can then allow the spotter to select between two or more vehicles to assign the enforcement activity to chase vehicle. Other processes can also or alternatively be used, such as allowing a spotter to claim the responsibility for stopping and citing the offending vehicle. The algorithm then proceeds to 310.

At 310, a selection is received. In one example embodiment, the selection can be a selection by the spotter of one or more officers to chase the offender, a selection of the first chase officer to respond, suitable selections. The algorithm then proceeds to 312.

At 312, a chase officer user interface is generated. In one example embodiment, the chase officer user interface can be generated on a smartphone or other suitable device of one or more chase officers to allow the chase officers to confirm the identity of the offending vehicle, to allow information regarding the location of the officer and offending vehicle to be tracked, and for suitable purposes. The algorithm then proceeds to 316.

At 314, chase vehicle operators can be solicited. In one example embodiment, if chase vehicle operators are solicited, the first chase vehicle o officer to respond can be selected automatically. Other suitable processes can also alternatively be used. The algorithm then proceeds to 316.

At 316, is determined whether multiple chase vehicles are involved in the enforcement activity. In one example embodiment, multiple chase vehicles can be assigned if there is a warrant for the arrest of the offending vehicle operator, if the offending vehicle is driving erratically or if other suitable conditions exist. If it is determined that multiple chase vehicles are not required, the algorithm proceeds to 322. Otherwise, the algorithm proceeds 318.

At 318, a chase vehicle is selected. The status of the chase vehicle can then be updated to indicate that it is engaged in a chase, a notification to the chase vehicle operator can be generated, the offense record can be updated, and other suitable processes can also or alternatively be implemented. The algorithm then proceeds to 320.

At 320, any additional chase vehicle user interfaces are generated, and the algorithm proceeds to 322.

At 322, it is determined whether the target has been stopped. In one example embodiment, a chase vehicle operator can use a control on their user interface device to update the status to show that the target vehicle has been stopped, has been lost or to report other conditions such as a crash, change of jurisdiction or the like. If the target vehicle has not been stopped, the algorithm proceeds to 326 and the database is updated, otherwise the algorithm proceeds to 324 where a vehicle image or other suitable data is added to the record.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for processing law enforcement data, comprising:
a speed detection system operating on a processor and configured to generate target vehicle speed information;
a spotter system operating on a second processor, the spotter system configured to receive the target vehicle speed information and to generate notification data; and
one or more chase system, each operating on an associated third processor, each chase system configured to receive the notification data and to identify a target vehicle associated with the notification data.

2. The system of claim 1 wherein the spotter system comprises an application operating on a smart telephone.

3. The system of claim 1 wherein the spotter system comprises an application operating on a smart telephone that is configured to generate session identifier data for transmission with the notification data.

4. The system of claim 1 wherein the spotter system comprises an application operating on a smart telephone that is configured to generate a user interface showing identification data and location data for each available chase system.

5. The system of claim 1 wherein the chase system comprises an application operating on a smart telephone that is remote from the speed detection system.

6. The system of claim 1 wherein the chase system comprises an application operating on a smart telephone that is configured to generate a response to the notification system to engage in a chase operation associated with the target vehicle.

7. The system of claim 1 wherein the chase system comprises an application operating on a smart telephone that is configured to generate a response to the notification system to engage in a chase operation associated with the target vehicle and to notify each other chase system that the chase operation has been claimed.

8. The system of claim 1 further comprising a centralized server system operating on a fourth processor and configured to receive the notification and additional data generated by the spotter system and each chase system that is associated with the target vehicle.

9. The system of claim 1 further comprising a centralized server system operating on a fourth processor and configured to receive the notification and additional data generated by the spotter system and each chase system that is associated with the target vehicle, and to generate citation data associated with the target vehicle that identifies one or more moving vehicle laws that have been violated and evidentiary data that is used to determined that the one or more moving vehicle laws have been violated.

10. The system of claim 1 further comprising a centralized server system operating on a fourth processor and configured to generate the spotter system on the second processor and the chase systems on each associated third processor.

11. A method for processing law enforcement data, comprising:
generating target vehicle speed information at a speed detection system operating on a first processor;
transmitting the target vehicle speed information from the speed detection system to a spotter system operating on a second processor;
receiving the target vehicle speed information as the spotter system and generating notification data; and
transmitting the notification data from the spotter system to one or more chase systems, each operating on a third processor;
receiving the notification data at one or more chase system; and
generating target vehicle identification data and associating the target vehicle identification data with the notification data.

12. The method of claim 11 wherein the spotter system comprises an application operating on a smart telephone.

13. The method of claim 11 wherein the spotter system comprises an application operating on a smart telephone that is configured to generate session identifier data for transmission with the notification data.

14. The method of claim 11 wherein the spotter system comprises an application operating on a smart telephone that is configured to generate a user interface showing identification data and location data for each available chase system.

15. The method of claim 11 wherein the chase system comprises an application operating on a smart telephone that is remote from the speed detection system.

16. The method of claim 11 wherein the chase system comprises an application operating on a smart telephone that is configured to generate a response to the notification system to engage in a chase operation associated with the target vehicle.

17. The method of claim 11 wherein the chase system comprises an application operating on a smart telephone that is configured to generate a response to the notification system to engage in a chase operation associated with the target vehicle and to notify each other chase system that the chase operation has been claimed.

18. The method of claim 11 further comprising:
receiving the notification and additional data generated by the spotter system at a centralized server system operating on a fourth processor; and
storing the notification and the additional data with data identifying each chase system that is associated with the target vehicle.

19. The method of claim 11 further comprising:
receiving the notification and additional data generated by the spotter system at a centralized server system operating on a fourth processor; and
generating citation data associated with the target vehicle that identifies one or more moving vehicle laws that have been violated and evidentiary data that is used to determined that the one or more moving vehicle laws have been violated.

20. The method of claim 11 further comprising generating the spotter system on the second processor and the chase systems on each associated third processor using a centralized server system operating on a fourth processor.
